(19) United States
(12) Patent Application Publication
(10) Pub. No.: US 2012/0200863 A1
(43) Pub. Date: Aug. 9, 2012

(54) Zone Based Resolution Settings For Identifying Document Portions Including Metadata

(75) Inventor: Louis Ormond, Irvine, CA (US)

(73) Assignees: Toshiba Tec Kabushiki Kaisha, Shinagawa-ku (JP); Kabushiki Kaisha Toshiba, Minato-ku (JP)

(21) Appl. No.: 13/308,295

(22) Filed: Nov. 30, 2011

Related U.S. Application Data
(60) Provisional application No. 61/440,298, filed on Feb. 7, 2011.

(51) Int. Cl. G06F 15/00

(52) U.S. Cl. 358/1.2

(57) ABSTRACT

There is disclosed a method and apparatus for zone based resolution settings for identifying document portions including metadata. The method includes scanning a physical document at a resolution suitable for obtaining metadata from a visible element on the physical document in order to obtain a digital representation of the physical document as an electronic document. The method continues by receiving user input as to a portion of the electronic document containing the visible element and reducing the resolution of the electronic document other than the portion. Finally, the metadata is obtained from the portion of the electronic document containing the visible element.

### RELATED APPLICATION INFORMATION

This patent claims priority from U.S. Provisional Patent Application No. 61/440,298 entitled “Zone Based Resolution Settings” filed Feb. 7, 2011.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to zone based resolution settings for identifying document portions including metadata.

2. Description of the Related Art

A multifunction peripheral (MFP) is a type of document processing device which is an integrated device providing at least two document processing functions, such as print, copy, scan and fax. In a document processing function, an input document (electronic or physical) is used to automatically produce a new output document (electronic or physical).

Documents may be physically or logically divided into pages. A physical document is paper or other physical media bearing information which is readable unaided by the typical human eye. An electronic document is any electronic media content (other than a computer program or a system file) that is intended to be used in either an electronic form or as printed output. Electronic documents may consist of a single data file, or an associated collection of data files which together are a unitary whole. Electronic documents will be referred to further herein as a document, unless the context requires some discussion of physical documents which will be referred to by that name specifically.

In printing, the MFP automatically produces a physical document from an electronic document. In copying, the MFP automatically produces a physical document from a physical document. In scanning, the MFP automatically produces an electronic document from a physical document. In faxing, the MFP automatically transmits via fax an electronic document from an input physical document which the MFP has also scanned or from an input electronic document which the MFP has converted to a fax format.

MFPs are often incorporated into corporate or other organization's networks which also include various other workstations, servers and peripherals. An MFP may also provide remote document processing services to external or network devices.

In order for systems to accurately obtain metadata encoded in a visible element appearing on the face of a document by scanning, it is preferable to scan the document at a high resolution. This ensures that an accurate image of the visible element suitable for detection by the MFP is available. However, scanning an entire document or entire sets of documents in very high resolution rapidly depletes storage space and makes the transmission of the resulting large electronic documents more taxing and slow on network systems.

### DESCRIPTION OF THE DRAWINGS

FIG. 1 is a diagram of an MFP system.

FIG. 2 is a block diagram of an MFP.

FIG. 3 is a block diagram of a computing device.

FIG. 4 is a block diagram of a software system for an MFP.

FIG. 5 is a document including a visible element used to identify document portions including metadata.

FIG. 6 is a portion of a user interface showing a scanned version of a document including a visible element.

FIG. 7 is the same portion of a user interface including a zoomed-in version of a document including a visible element.

FIG. 8 is a portion of a user interface showing a manual input for the location of a visible element.

FIG. 9 is a flowchart for the operation of the zone based resolution settings for identifying document portions including metadata.

Throughout this description, elements appearing in figures are assigned three-digit reference designators, where the most significant digit is the figure number and the two least significant digits are specific to the element.

### DETAILED DESCRIPTION

Description of Apparatus

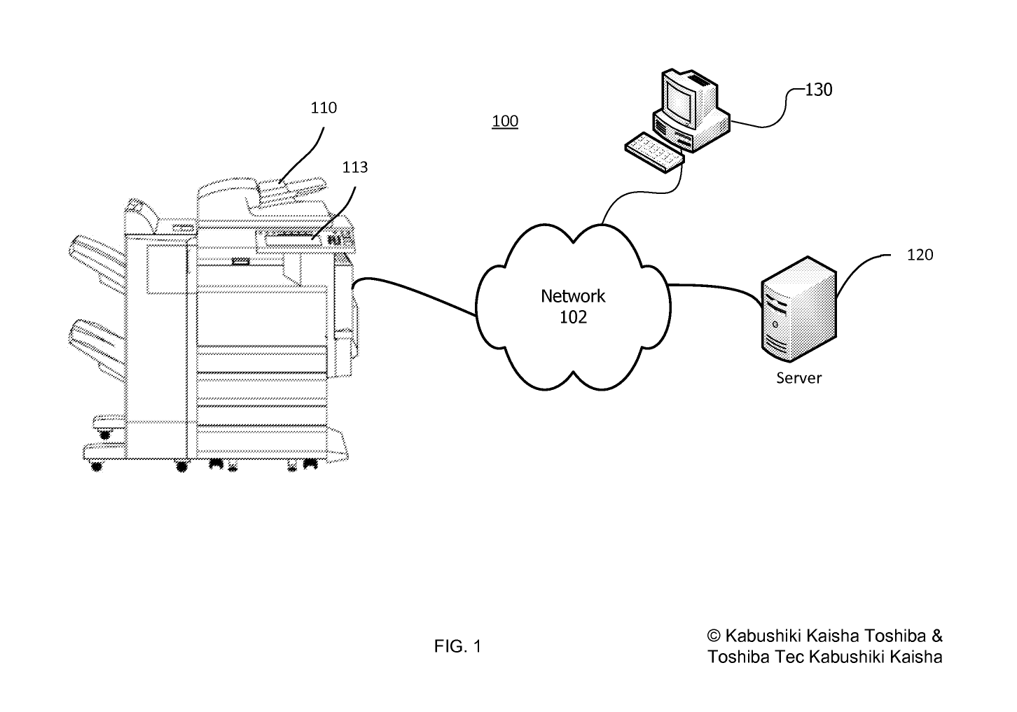

Referring now to FIG. 1 there is shown an MFP system 100. The system 100 includes an MFP 110, a server 120, and a client computer 130, all interconnected by a network 102. The system 100 may be implemented in a distributed computing environment and interconnected by the network 102.

The network 102 may be a local area network, a wide area network, a personal area network, the Internet, an intranet, or any combination of these. The network 102 may have physical layers and transport layers according to IEEE 802.11, Ethernet or other wireless or wire-based communication standards and protocols such as WIMAX®, BLUETOOTH®, the public switched telephone network, a proprietary communications network, infrared, and optical.

The MFP 110 may be equipped to receive portable storage media such as USB drives. The MFP 110 includes a user interface subsystem 113 which communicates information to and receives selections from users. The user interface subsystem 113 has a user output device for displaying graphical elements, text data or images to a user and a use input device for receiving user inputs. The user interface subsystem 113 may include a touchscreen, LCD display, touch-panel, alpha-numeric keypad and/or an associated thin client through which a user may interact directly with the MFP 110.

The server 120 is software operating on a server computer connected to the network. The client computer 130 may be a PC, thin client or other device. The client computer 130 is representative of one or more end-user devices and may be considered separate from the system 100.

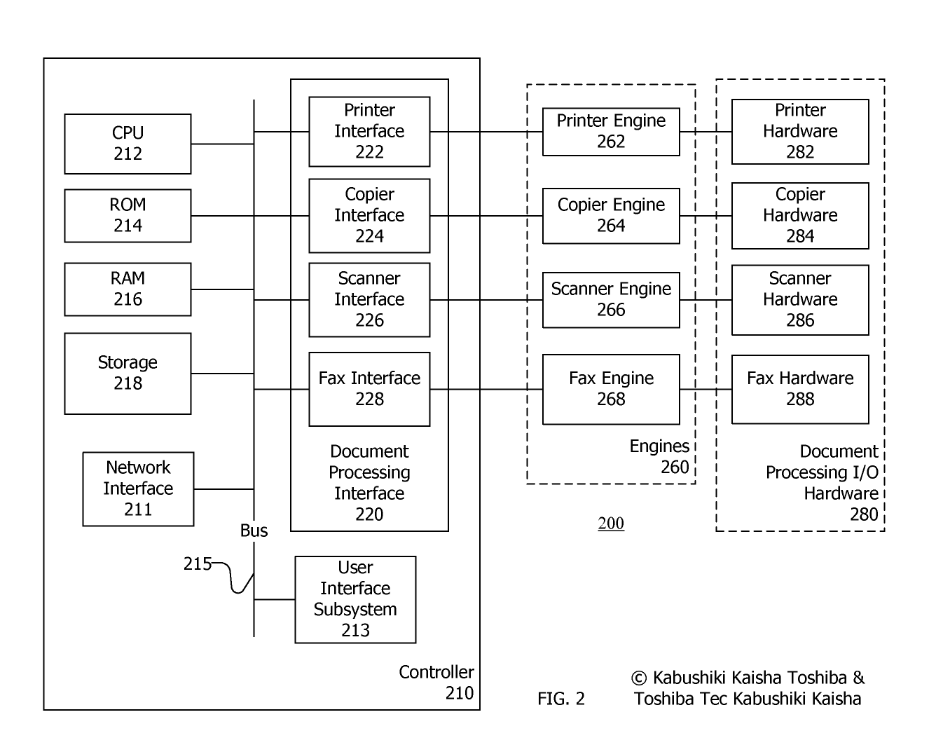

Turning now to FIG. 2 there is shown a block diagram of an MFP 200 which may be the MFP 110 (FIG. 1). The MFP 200 includes a controller 210, engines 260 and document processing I/O hardware 280. The controller 210 includes a CPU 212, a ROM 214, a RAM 216, a storage 218, a network interface 211, a bus 215, a user interface subsystem 213 and a document processing interface 220.

As shown in FIG. 2 there are corresponding components within the document processing interface 220, the engines 260 and the document processing I/O hardware 280, and the components are respectively communicative with one another. The document processing interface 220 has a printer interface 222, a copier interface 224, a scanner interface 226 and a fax interface 228. The engines 260 include a printer engine 262, a copier engine 264, a scanner engine 266 and a fax engine 268. The document processing I/O hardware 280 includes printer hardware 282, copier hardware 284, scanner hardware 286 and fax hardware 288.

The MFP 200 is configured for printing, copying, scanning and faxing. However, an MFP may be configured to provide other document processing functions, and, as per the definition, as few as two document processing functions.

The CPU 212 may be a central processor unit or multiple processors working in concert with one another. The CPU 212 carries out the operations necessary to implement the functions provided by the MFP 200. The processing of the CPU 212 may be performed by a remote processor or distributed processor or processors available to the MFP 200. For example, some or all of the functions provided by the MFP 200 may be performed by a server or thin client associated with the MFP 200, and these devices may utilize local resources (e.g., RAM), remote resources (e.g., bulk storage), and resources shared with the MFP 200.

The ROM 214 provides non-volatile storage and may be used for static or fixed data or instructions, such as BIOS functions, system functions, system configuration data, and other routines or data used for operation of the MFP 200.

The RAM 216 may be DRAM, SRAM or other addressable memory, and may be used as a storage area for data instructions associated with applications and data handling by the CPU 212.

The storage 218 provides volatile, bulk or long term storage of data associated with the MFP 200, and may be or include disk, optical, tape or solid state storage. The three storage components, ROM 214, RAM 216 and storage 218 may be combined or distributed in other ways, and may be implemented through SAN, NAS, cloud or other storage systems.

The network interface 211 interfaces the MFP 200 to a network, such as the network 102 (FIG. 1), allowing the MFP 200 to communicate with other devices.

The bus 215 enables data communication between devices and systems within the MFP 200. The bus 215 may conform to the PCI Express or other bus standard.

While in operation, the MFP 200 may operate substantially autonomously. However, the MFP 200 may be controlled from and provide output to the user interface subsystem 213, which may be the user interface subsystem 113 (FIG. 1).

The document processing interface 220 may be capable of handling multiple types of document processing operations and therefore may incorporate a plurality of interfaces 222, 224, 226 and 228. The printer interface 222, copier interface 224, scanner interface 226, and fax interface 228 are examples of document processing interfaces. The interfaces 222, 224, 226 and 228 may be software or firmware.

Each of the printer engine 262, copier engine 264, scanner engine 266 and fax engine 268 interact with associated printer hardware 282, copier hardware 284, scanner hardware 286 and facsimile hardware 288, respectively, in order to complete the respective document processing functions. These engines may be software, firmware or a combination of both that enable the document processing interface 220 to communicate with the document processing I/O hardware 280.

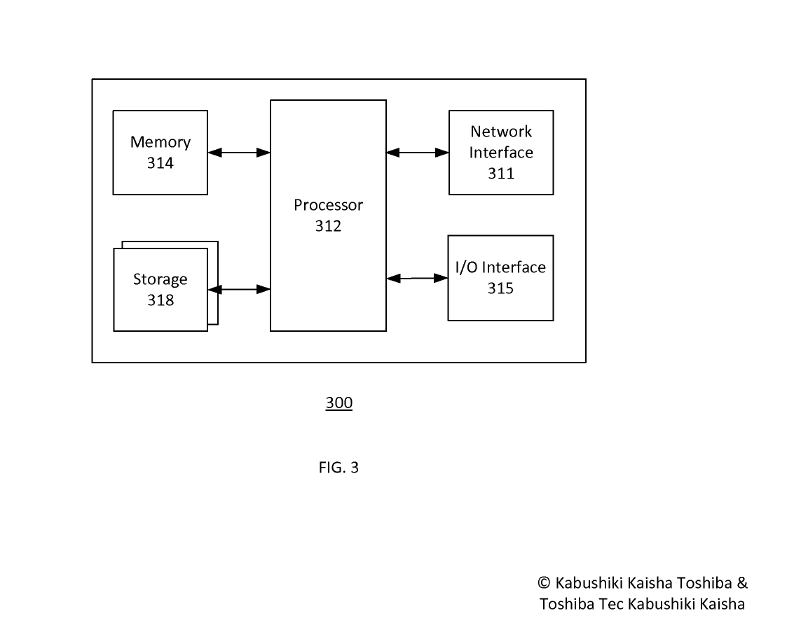

Turning now to FIG. 3 there is shown a computing device 300, which is representative of the server computers, client devices and other computing devices discussed herein. The controller 210 (FIG. 2) may also, in whole or in part, incorporate a general purpose computer like the computing device 300. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 has a processor 312 coupled to a memory 314, storage 318, a network interface 311 and an I/O interface 315. The processor may be or include one or more microprocessors, field programmable gate arrays (FPGAs), application specific integrated circuits (ASICs), programmable logic devices (PLDs) and programmable logic arrays (PLAs).

The memory 314 may be or include RAM, ROM, DRAM, SRAM and MRAM, and may include firmware, such as static data or fixed instructions, BIOS, system functions, configuration data, and other routines used during the operation of the computing device 300 and processor 312. The memory 314 also provides a storage area for data and instructions associated with applications and data handled by the processor 312.

The storage 318 provides non-volatile, bulk or long term storage of data or instructions in the computing device 300. The storage 318 may take the form of a disk, tape, CD, DVD, or other reasonably high capacity addressable or serial storage medium. Multiple storage devices may be provided or available to the computing device 300. Some of these storage devices may be external to the computing device 300, such as network storage or cloud-based storage.

As used herein, the term storage medium corresponds to the storage 318 and does not include transitory media such as signals or waveforms.

The network interface 311 includes an interface to a network such as network 102 (FIG. 1).

The I/O interface 315 interfaces the processor 312 to peripherals (not shown) such as displays, keyboards and USB devices.

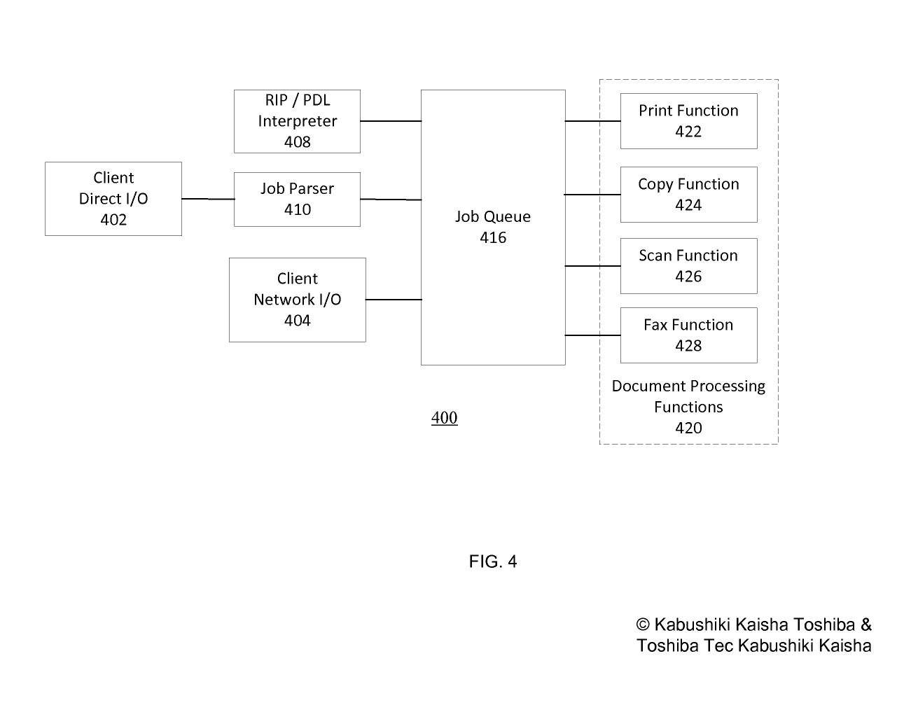

Turning now to FIG. 4 there is shown a block diagram of a software system 400 of an MFP which may operate on the controller 210 (FIG. 2). The system 400 includes client direct I/O 402, client network I/O 404, a RIP / PDL interpreter 408, a job parser 410, a job queue 416, a series of document processing functions 420 including a print function 422, a copy function 424, a scan function 426 and a fax function 428.

The client direct I/O 402 and the client network I/O 404 provide input and output to the MFP controller. The client direct I/O 402 is for the user interface on the MFP (e.g., user interface subsystem 113), and the client network I/O 404 is for user interfaces over the network. This input and output may include documents for printing or faxing or parameters for MFP functions. In addition, the input and output may include control of other operations of the MFP. The network-based access via the client network I/O 404 may be accomplished using HTTP, FTP, UDP, electronic mail TELNET or other network communication protocols.

The RIP/PDL interpreter 408 transforms PDL-encoded documents received by the MFP into raster images or other forms suitable for use in MFP functions and output by the MFP. The RIP/PDL interpreter 408 processes the document and adds the resulting output to the job queue 416 to be output by the MFP.

The job parser 410 interprets a received document and relays it to the job queue 416 for handling by the MFP. The job parser 410 may perform functions of interpreting data received so as to distinguish requests for operations from documents and operational parameters or other elements of a document processing request.

The job queue 416 stores a series of jobs for completion using the document processing functions 420. Various image forms, such as bitmap, page description language or vector format may be relayed to the job queue 416 from the scan function 426 for handling. The job queue 416 is a temporary repository for all document processing operations requested by a user, whether those operations are received via the job parser 410, the client direct I/O 402 or the client network I/O 404. The job queue 416 and associated software is responsible for determining the order in which print, copy, scan and facsimile functions are carried out. These may be executed in the order in which they are received, or may be influenced by the user, instructions received along with the various jobs or in other ways so as to be executed in different orders or in sequential or simultaneous steps. Information such as job control, status data, or electronic document data may be exchanged between the job queue 416 and users or external reporting systems.

The job queue 416 may also communicate with the job parser 410 in order to receive PDL files from the client direct I/O 402. The client direct I/O 402 may include printing, fax transmission or other input of a document for handling by the system 400.

The print function 420 enables the MFP to print documents and implements each of the various functions related to that process. These include stapling, collating, hole punching, and similar functions. The copy function 422 enables the MFP to perform copy operations and all related functions such as multiple copies, collating, 2 to 1 page copying or 1 to 2 page copying and similar functions. Similarly, the scan function 426 enables the MFP to scan and to perform all related functions such as shrinking scanned documents, storing the documents on a network or emailing those documents to an email address. The fax function 426 enables the MFP to perform facsimile operations and all related functions such as multiple number fax or auto-redial or network-enabled facsimile.

Some or all of the document processing functions 420 may be implemented on a client computer, such as a personal computer or thin client. The user interface for some or all document processing functions may be provided locally by the MFP's user interface subsystem though the document processing function is executed by a computing device separate from but associated with the MFP.

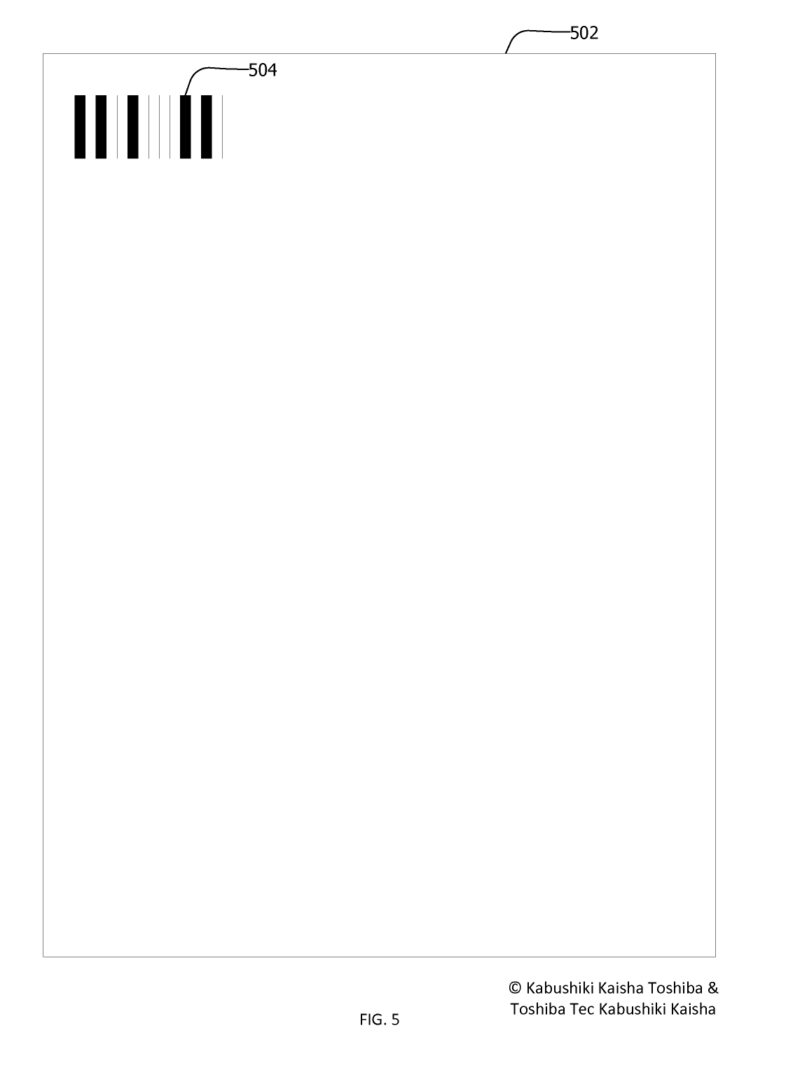

Turning now to FIG. 5 there is shown a document 502 including a visible element 504 used to identify document portions including metadata. The document 502 may be a document that a user wishes to have archived to a particular location or to which a user wishes to have faxed or emailed to a particular recipient. The incorporation of the visible element 504 including metadata enables the user to direct the MFP to operate on the document 502 in a particular way based upon the metadata encoded in the visible element.

The visible element 504 shown in this document is a two-dimensional barcode. However, three dimensional barcodes may be used as may document numbers, project numbers or various other types of stamps or other elements that may be included on the face of a document. In the case of any of these visible elements, such as visible element 504, the metadata may be self-evident to an MFP upon scanning the visible element 504 or may refer the MFP to a particular data storage location at which related metadata may be accessed.

For example, the metadata in the visible element 504 may, itself, indicate that the document is to be stored in a particular directory on a particular server. Alternatively, the metadata in the visible element 504 may direct the MFP to a data location on a related database server, the data location storing the directory on a server where the document 502 is to be stored. In yet another alternative, the metadata stored in the visible element 504 may be used by a system other than the MFP at a later time. As such, the integrity of the visible element 504 must be maintained until the document 502 reaches the other system.

In order to extract the metadata stored in the visible element 504, the MFP (or other system) must be able to accurately determine the content of the metadata stored in the visible element 504. As such, the MFP must scan the visible element 504 with sufficient clarity and detail that it is able to accurately ascertain the metadata stored therein.

In order to do this, documents, such as document 502, may be scanned at a very high resolution, such as the maximum resolution or one of very high quality. However, it is undesirable to store the entire document 502 at such a high resolution because the document would take up a great deal of data storage space and any repository or email address to which the document 502 is directed in electronic form would rapidly reach capacity.

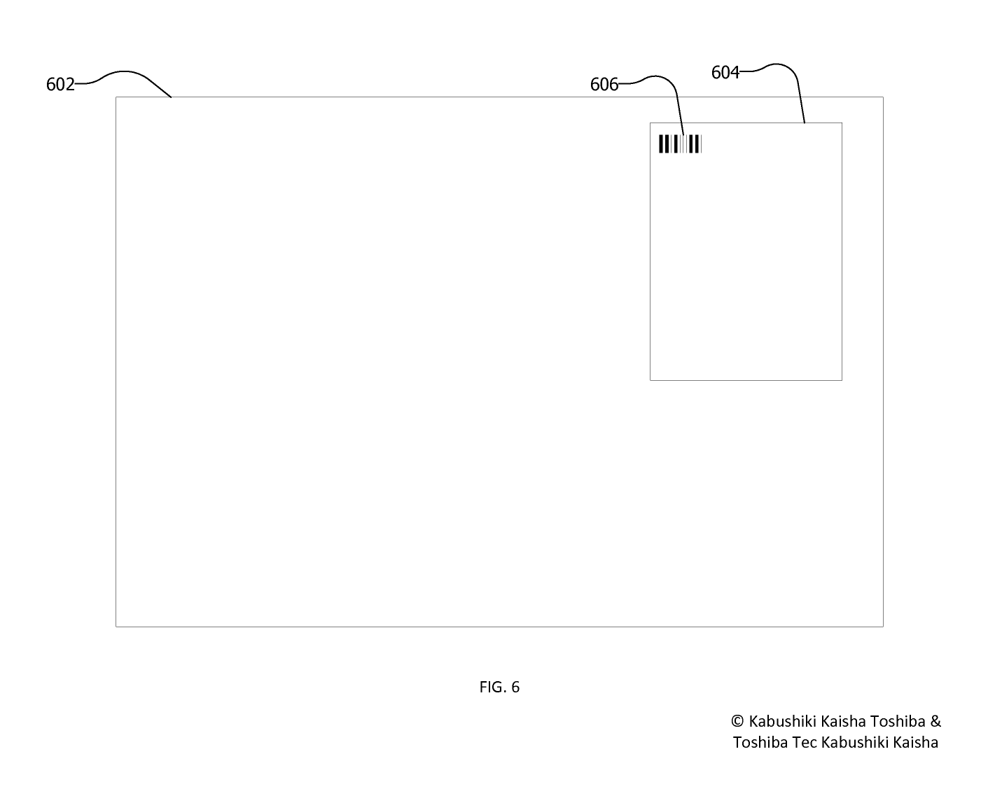

Turning now to FIG. 6 a portion of a user interface 602 showing a scanned version of a document 604 including a visible element 606 is shown. This portion of a user interface 602 may be visible on an MFP after a user has requested scanning of a document, such as document 604. The user may be prompted to indicate the location of the visible element 606 on the electronic version of the document 604. As can be seen in FIG. 6, the document 604 appears as only a small part of the portion of a user interface 602.

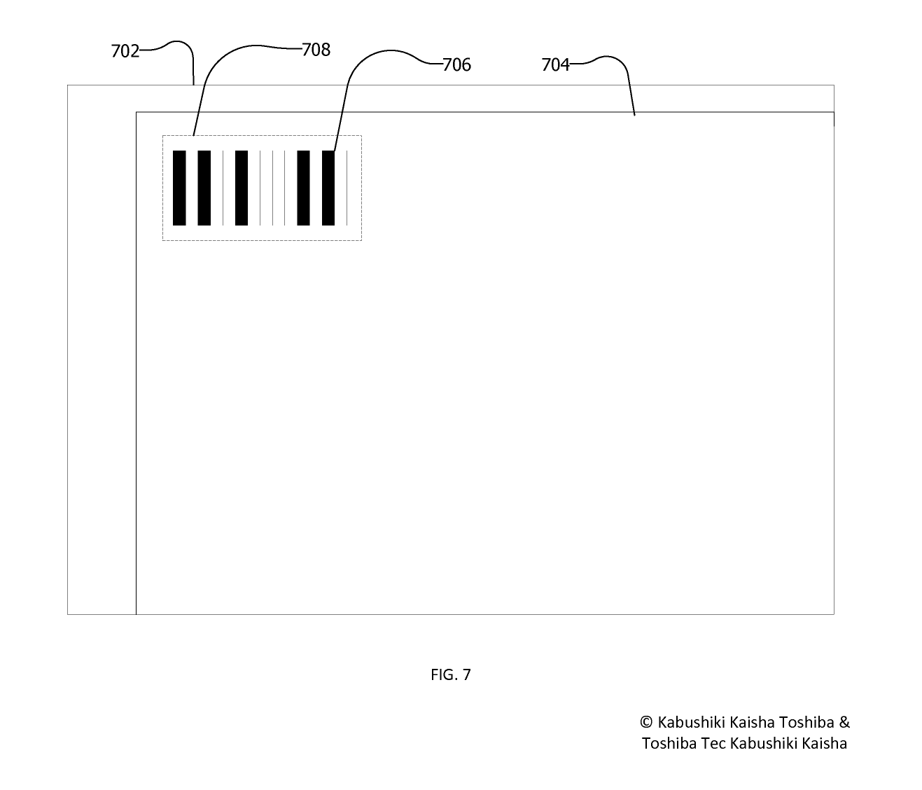

FIG. 7 shows the same portion of a user interface 702 including a zoomed-in version of a document 704 including a visible element 706. The user may utilize a touchscreen or operational buttons or keys associated with the user interface 702 to request that the document 704 be zoomed so as to aid the user in identifying the portion of the document 704 including the visible element 706. FIG. 7 shows the results after that request has been processed.

Next, the user may utilize the touchscreen or operational buttons or keys to indicate a selection area 708 of the document 704 that includes the visible element 706 incorporating metadata. The user may draw the selection area 708 around the visible element 706, the user may touch a portion of the user interface 702 and then drag his or her finger to another portion to highlight the visible element 706. Alternatively, the user may utilize operational buttons, keys or otherwise manipulate a cursor on the user interface 702 so as to indicate a selection area 708 to the MFP. Using one or more of these options, a user can indicate a selection area 708 at the location of the visible element 706 on the document 704.

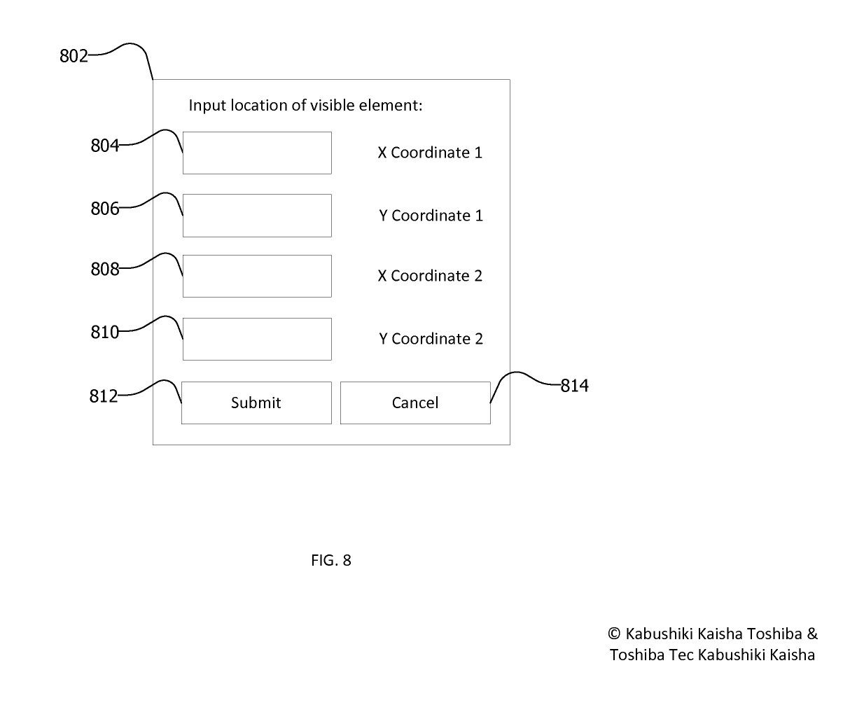

Turning now to FIG. 8, a portion of a user interface 802 showing a manual input for the location of a visible element is shown. An x coordinate 1 input 804, a y coordinate 1 input 806, an x coordinate 2 input 808, a y coordinate 2 input 810, a submit button 812 and a cancel button 814 are shown. The user may input the two (x, y) coordinate combinations in order to designate the two farthest points of a rectangle encompassing the visible element.

Alternatively, the coordinate inputs may be replaced with a single coordinate input and a length and width input or a set of descriptors designating the physical location on the counterpart physical document. These descriptors may indicate that the visible element begins one inch from the top and one inch from the left side and extends for one inch downward and two inches to the right. In yet another alternative, general descriptors or a default set of descriptors may be used or selected from such as “the top left of the page,” “the top right of the page,” “the bottom of the page” and similar designations. These general descriptors or a default set of descriptors may be pre-set by an administrator using either the MFP or an administrative computer. An organization-wide location on physical documents may be defined by an administrator for use as one of these descriptors.

However the zone containing the visible element is identified, the use of zone based resolution settings enables the benefits of visible elements on physical documents to be obtained without the necessity of vast amounts of storage space or bandwidth for electronic documents. In particular, the documents may be scanned at a sufficiently-high resolution that may be legible and useful for whatever purposes the organization desires. However, the individual portions of those documents containing visible elements may be scanned and stored at a very high resolution.

This dual capability enables an organization to enjoy the benefit of accurately identifying metadata stored in the visible element of the electronic document without needing to store the entire document or all documents at a high resolution and, thus, requiring substantially less storage space and transmission bandwidth for the entire document.

Description of Processes

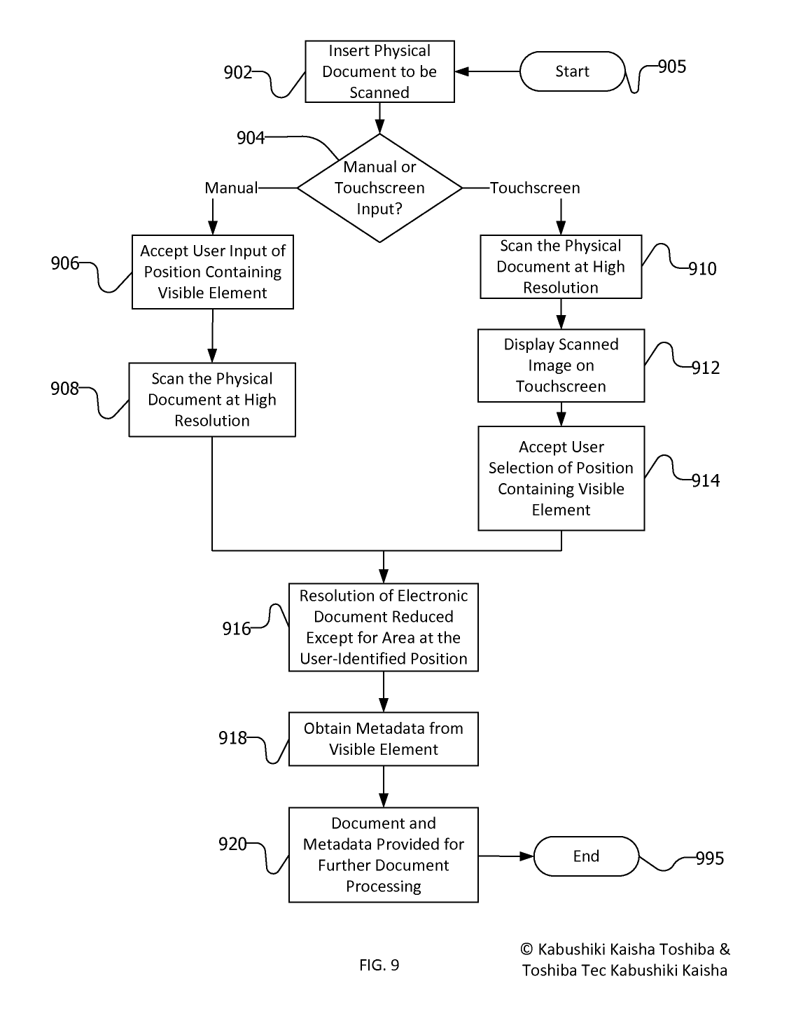

Turning now to FIG. 9, there is shown a flowchart for the operation of the zone based resolution settings for identifying document portions including metadata. First, a physical document is inserted into the MFP to be scanned at 902. At this point, the MFP may immediately prompt a user to indicate the method by which the user will input the location of the visible element including metadata. This prompt may be a portion of the user interface. Alternatively, the MFP may include an option by which a user indicates, first, that there is a visible element incorporating metadata and, then, selects the method by which the location of the visible element on the document will be identified.

In either case, the user selects one of manual input or touchscreen input at 904. If the user selects manual input, the user will be prompted via a user interface, such as user interface 802 (FIG. 8) to input the position containing a visible element at 906. Next, the entire physical document is scanned at a high resolution at 908. This high resolution scanning ensures that the visible element is scanned at high enough resolution to accurately ascertain the encoded metadata.

If the user elects to utilize touchscreen input at 904, then the physical document is scanned at a high resolution at 910. Again, this resolution is high enough to ensure that the metadata may be ascertained from the visible element. Next, the scanned image is displayed on the touchscreen at 912 so that the user can identify the location of the visible element on the electronic document. The user selection of the position containing the visible element is accepted at 914. This may take place, for example, by means of a touchscreen user interface such as shown in FIG. 7 whereby the user outlines, highlights or otherwise provides the boundaries defining the location of the visible element.

In some cases, an administrator may disable the selection between manual input or touchscreen input at 904 thereby enabling only a single type of input. This may be disabled using a login to the MFP or using an administrative system for controlling access to the MFP. In still other situations, an administrator may require the user to utilize either manual input or touchscreen input or, otherwise, the MFP scanning capability is disabled. In this way, an administrator can ensure that documents containing visible elements including metadata are properly identified and, as a result, properly stored or otherwise dealt with as desired by the organization.

When a single document is made up of multiple pages, the visible element may appear only on the first page or on each of the pages of the document. If the visible element appears only on the first page, the remaining pages of the document may be scanned at a low resolution. If the visible element appears on every page, the document may be scanned at high resolution and then be reduced in resolution in all areas except those containing the visible element on each page. The location of the visible element may be determined on a page-by-page basis or may be selected by a user once and applied to each page.

Once the document is scanned and the location of the visible element has been identified by either manual or touchscreen input, the resolution of the electronic document is reduced except for the area at the user-identified position of the visible element at 916. At this stage, the remainder of the electronic document may be lowered in resolution. This process may be undertaken in a number of ways. A meta-document may be used whereby the electronic document contains the primary document in a reduced resolution and maintains the user-identified portion of the document including the visible element as a high-resolution sub-image. The documents may be related using metadata or an encapsulated data format.

Alternatively, the electronic document may be reduced in resolution by using larger pixels for the majority of the electronic document than are used for the portion of the electronic document incorporating the visible element. In this method, the actual pixel-count may not be altered, but the image may utilize image compression so as to define areas of lower resolution within the image, thereby requiring less storage capacity. In this way, the overall compressed image appears to utilize fewer pixels-per-inch and thereby reduces the necessary data to store the electronic document. The portion of the document including the visible portion will not have its resolution reduced and will, therefore, maintain clarity. In this way, a single electronic document may be reduced in storage size except for the portion containing the visible element.

The metadata is then obtained from the visible element at 918. This may take place using optical character recognition or similar methodology in order to ascertain the contents of the visible element. The visible element itself may contain the metadata or may direct the MFP to a server containing the full metadata associated with the visible element. The MFP may obtain the metadata or it may be obtained by a server or other computer to which the MFP has provided the electronic document.

Once obtained, the document and metadata are provided to another aspect of the MFP, to an external computing device or to a document server for further document processing at 920. This document processing may be emailing to a particular user, storage to a document server, optical character recognition of the contents of the document by the MPF or an external computing device or any number of other document processing operations.

The flow chart of FIG. 9 has both a start 905 and an end 995, but the process is cyclical in nature and may relate to one or more simultaneous instances of zone based resolution settings for identifying document portions including metadata taking place in parallel or in serial.

Closing Comments

Throughout this description the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for using zone based resolution settings to identify a document portion including metadata:
scanning a physical document at a resolution suitable for obtaining metadata from a visible element on the physical document in order to obtain a digital representation of the physical document as an electronic document;
receiving user input as to a portion of the electronic document containing the visible element; and
reducing the resolution of the electronic document other than the portion containing the visible element.

2. The method of claim 1 wherein the resolution of the electronic document other than the portion is reduced to a default resolution.

3. The method of claim 1 wherein the resolution of the electronic document other than the portion is reduced to a user-selected resolution.

4. The method of claim 1 wherein the user input is received in the form of an (x,y) coordinate designating a portion of the physical document before scanning.

5. The method of claim 1 further comprising:
presenting a version of the electronic document on a display; and
wherein the user input is received in the form of a targeted area on the display corresponding to the portion containing the visible element.

6. The method of claim 5 wherein the display includes a touchscreen and the user input is received via the touchscreen.

7. The method of claim 1 further comprising providing the electronic document and the metadata to another computing device in order to perform further document processing.

8. A multifunction peripheral including:
a scanner to scan a physical document at a resolution suitable for obtaining metadata from a visible element on the physical document in order to obtain a digital representation of the physical document as an electronic document;
a user interface to receive user input as to a portion of the electronic document containing the visible element; and
a processor to reduce the resolution of the electronic document other than the portion containing the visible element.

9. The multifunction peripheral of claim 8 wherein the resolution of the electronic document other than the portion is reduced to a default resolution.

10. The multifunction peripheral of claim 8 wherein the resolution of the electronic document other than the portion is reduced to a user-selected resolution.

11. The multifunction peripheral of claim 8 wherein the user input is received in the form of an (x, y) coordinate designating a portion of the physical document before scanning.

12. The multifunction peripheral of claim 8 wherein the user interface further comprises a display for presenting a version of the electronic document in order to receive user input in the form of a targeted area on the display corresponding to the portion containing the visible element.

13. The multifunction peripheral of claim 12 wherein the display includes a touchscreen and the user input is received via the touchscreen.

14. The multifunction peripheral of claim 8 wherein the processor is further to provide the electronic document and the metadata to another computing device in order to perform further document processing.

15. Apparatus comprising a storage medium storing a program having instructions which when executed by a processor within a multifunction peripheral will cause the multifunction peripheral to:
scan a physical document at a resolution suitable for obtaining metadata from a visible element on the physical document in order to obtain a digital representation of the physical document as an electronic document;
receive user input as to a portion of the electronic document containing the visible element; and
reduce the resolution of the electronic document other than the portion containing the visible element

16. The apparatus of claim 15 wherein the resolution of the electronic document other than the portion is reduced to a default resolution.

17. The apparatus of claim 15 wherein the resolution of the electronic document other than the portion is reduced to a user-selected resolution.

18. The apparatus of claim 15 wherein the user input is received in the form of an (x,y) coordinate designating a portion of the physical document before scanning.

19. The apparatus of claim 15 further comprising a touchscreen display for presenting a version of the electronic document in order to receive user input via the touchscreen in the form of a targeted area on the display corresponding to the portion containing the visible element.

20. The apparatus of claim 15 wherein the program further causes the processor to provide the electronic document and the metadata to another computing device in order to perform further document processing.
